(19) United States
(12) Patent Application Publication
(10) Pub. No.: US 2025/0285168 A1
(43) Pub. Date: Sep. 11, 2025

(54) Wearable QR Codes Linked to Specific Information

(71) Applicant: Jennifer DiStefano Truesdell, Stafford, VA (US)

(72) Inventor: Jennifer DiStefano Truesdell, Stafford, VA (US)

(21) Appl. No.: 18/597,833

(22) Filed: Mar. 6, 2024

Related U.S. Application Data
(60) Provisional application No. 63/478,721, filed on Jan. 6, 2023.

(51) Int. Cl. G06Q 30/0601; G06K 19/06

(52) U.S. Cl. CPC G06Q 30/0641; G06K 19/06037; G06Q 30/0621

(57) ABSTRACT

A QR code system adapted for use with clothing articles, the QR code system comprising at least one QR code which has been embedded within an article of clothing and which contains specific information or intelligence which can be accessed by an electronic scanner such as a mobile smart phone. In operation, a user scans the QR code and is connected to an internet website such as an online merchandise store for purchasing the article of clothing, a music streaming service or website showcasing a recording artist, song or album, an education website, a toy company, a business website or social media platforms. The QR code system creates a positive user experience of direct connection to a message, website, link, action, music, and/or it reveals an active or static 3D image that emanates from the graphic on the apparel. In addition, the QR code system adapted for use with clothing articles enables quick and easy access to an internet address and the article of clothing serves as a promotional and marketing tool with quick and easy access to the source of the specific information.

### CROSS-REFERENCE TO RELATED APPLICATIONS

This application claims the benefit of U.S. Provisional Patent Application No. 63/478,721, filed Jan. 6, 2023, which is incorporated herein in its entirety by reference. least one specification heading is required.

### FIELD OF INVENTION

The present subject matter is directed to an article of clothing having one or more QR codes containing specific information embedded within the article of clothing and a method of utilizing the QR code to connect the user to a particular internet address, website, online merchandise store or social media site.

### BACKGROUND OF THE INVENTION

Clothing articles have been imprinted with various graphic designs depicting a wide variety of images and statements. Various methods such as silk screening and photo transfer have been used in the past to provide a particular image to a clothing article. And of course, clothing articles have been branded with logos in various shapes and styles. However, none of these imprints have enabled either the wearer or an observer to quickly identify how and wear to purchase a particular article of clothing.

### PRIOR ART

There have been numerous developments in the use of QR (Quick Response) code systems in recent years to enable a user to scan a particular QR code to access specific information. For example, many restaurants now provide their customers with a QR code table tent that the individual diner can scan with their smart phone and link to the restaurant's menu. Not only does the use of the QR code table tent offer the customer a germ-free paperless menu but it enables the restaurant to update its menu without the need to continually print new paper copies. Typically, an internet-based service provides the restaurant with one or more QR codes for its menus and enables access of the menus via its internet service.

Recently, the idea of using a QR code on an article of clothing rather than the standard cloth label has been developed. For example, U.S. Patent Application 2022/0318888 AI to Mellin et al. discloses a QR code which is printed or embedded into a clothing article and which is provided with specific product information. When the QR code is scanned, the user can access the product information. And, Mellin provides enabling the manufacturer to digitally track and analyze the product throughout its lifecyle for market study and sales record keeping. Similarly, WO Application 2020/158961 AI to Han discloses a method and system for providing product information using a QR code attached to clothing, shoes, or bags. However, neither Mellin et al. or Wan contemplates using the QR code to enable the user to access a particular website, online merchandise store or social media site.

WO Patent Application 2022-21261A AI to Durham generally relates to a QR code for an item, article of product supplying source information and product availability, authenticity confirmation, details of manufacture and similar product information which is accessible through a scanner-enabled smartphone and internet connection.

### SUMMARY OF THE INVENTION

The present subject matter is directed to a QR code system comprising at least one QR code which is embedded into an article of clothing and which contains specific information or intelligence which may be accessed by means of any electronic QR scanner which connects the user to an internet address (URL) in such a manner that the user, once connected, can access certain information including how to purchase the same article of clothing and to facilitate the actual purchase of the clothing item. Preferably, the QR scanner is a mobile smart phone with scanning capability which connects the user to a particular internet network, website or social media site, for example Instagram. More preferably, the QR code is incorporated within a graphic design. When the graphic is scanned, such as by a mobile smart phone, it creates a positive user experience of direct connection to a message, website, link, action, music and/or it reveals a 3D image, active or static, that emanates from the graphic on the apparel. With respect to a QR code have intelligence to create a 3D image, this experience leads to 3D videos of augmented reality (AR).

Accordingly, it is an object of the present subject matter to provide a QR code system comprising at least one QR code which is embedded into an article of clothing and which contains specific information or intelligence which may be accessed by means of any electronic QR scanner which connects the user to an internet address (URL) in such a manner that the user, once connected, can access purchasing information about the article of clothing and to facilitate the actual purchase of the clothing item.

It is another object of the present subject matter to provide an article of clothing having a QR code embedded therein which can be scanned by an electronic scanning device such as a mobile smart phone and connect the user to an online merchandise store selling the article of clothing, thereby enabling the user to purchase the article of clothing.

It is a further object of the present subject matter to provide a QR code incorporated into a graphic design which is embedded into an article of clothing from a small business, wherein the QR code can be scanned by an electronic scanning device such as a mobile smart phone to provide an instant link to the small business website, thereby enabling the user with easy and fast exposure to the small business.

It is yet another object of the present subject matter to provide an article of clothing for a child's toy wherein said toy article of clothing has a QR code embedded therein which can be scanned by an electronic scanning device such as a mobile smart phone to link the user to the toy manufacturer's website.

It is still another object of the present subject matter to provide an article of clothing having a QR code embedded therein which can be scanned by an electronic scanning device such as a mobile smart phone and connect the user to a social media application or to a streaming music service.

It is an additional object of the present subject matter to provide an article of clothing having a QR code embedded therein which can be scanned by an electronic scanning device such as a mobile smart phone and connect the user to a website to receive a motivational quote, a nugget of knowledge or instructions for a child.

It is another object of the present subject matter to provide a QR system embedded in an article clothing which will enhance marketing and promotion for an apparel business.

It is a further object of the present subject matter to provide at least one graphic image on an article of clothing having a QR code embedded in the graphic design, the QR code containing data which, when accessed by an electronic scanning device such as a smart phone, reveals either an active or static 3D image that emanates from the graphic design on the article of clothing.

It is another object of the present subject matter to provide at least one graphic image on an article of clothing having a QR code embedded within the graphic design, the QR code containing data which, when accessed by an electronic scanning device such as a smart phone, reveals either an active or static 3D image that emanates from the graphic design on the article of clothing, thereby creating one or more 3D videos of augmented reality (AR).

It is still another object of the present subject to provide an article of clothing having a QR code embedded therein, wherein when the QR code is scanned by an electronic scanner to activate another smart device.

It is yet another object of the present subject matter to provide an article of clothing wearable electronics and flexible technology embedded therein.

It is an additional object of the present subject matter to provide an article of clothing designed to house and power smart devices.

Additional objects, advantages and novel features of the invention will be set forth in part in the description which follows, and in part will become apparent to those skilled in the art upon examination of the following specification or may be learned by practice of the invention. least one specification heading is required.

### BRIEF DESCRIPTION OF DRAWINGS

FIG. 1 illustrates a flow diagram of the present subject matter depicting an article of clothing having a QR code embedded therein which is scanned by a smart phone and connects to a website and its online merchandise store.

FIG. 2 shows an embodiment of the present subject matter in the form of an article of clothing having a QR code embedded therein which is scanned by a smart phone and connects to a streaming music platform.

FIG. 3 shows another embodiment of the present subject matter in the form of an article of clothing for a child's toy having a QR code embedded therein which is scanned by a smart phone and connects to the toy company's website.

FIG. 4 illustrates an embodiment of the present subject wherein the QR code is embedded on the back side of an article of clothing and contains intelligence to link to a social media platform such as Instagram™.

FIG. 5 depicts an embodiment of the present subject matter in the form of an article of clothing have multiple custom QR codes embedded therein which can be scanned by a smart phone to connect to specific social media sites.

FIG. 6 illustrates another embodiment of the present subject matter in the form of an article of clothing having a QR code embedded therein which can be scanned by a smart phone to produce a 3D experience for the scanner.

FIG. 7 shows an embodiment of the present invention in the form of an article of clothing having a particular QR code embedded on two areas of the article of clothing.

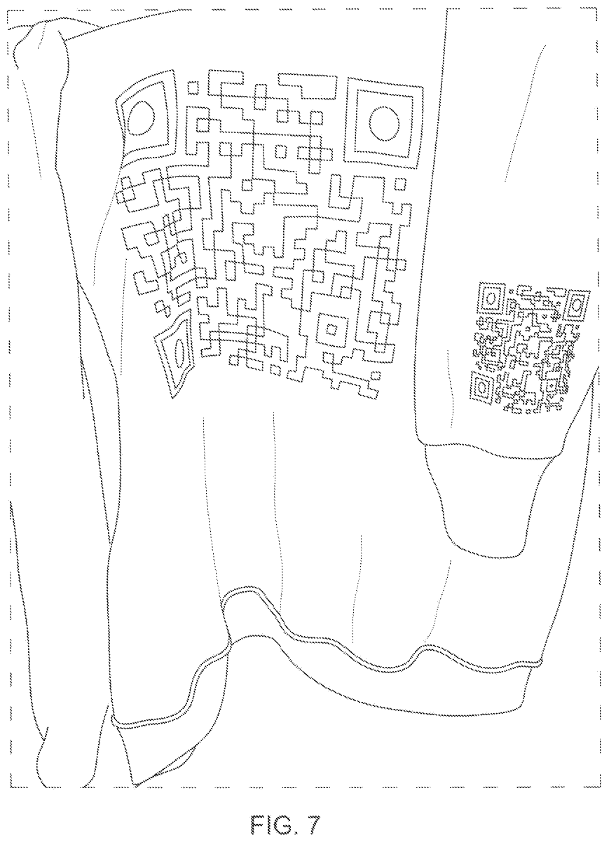

### DETAILED DESCRIPTION OF THE INVENTION

In the following description, numerous specific details are set forth to clearly describe various specific embodiments disclosed herein. However, one skilled in the art will understand that the presently claimed invention may be practiced without all of the specific details discussed below. In other instances, well known features have not been described so as not to obscure the invention.

Further, it is to be understood that the phraseology and terminology used herein is for the purpose of description and should not be regarded as limiting. The use of the terms “including,” “comprising,” or “having” and variations thereof herein is meant to encompass the items listed thereafter and equivalents thereof as well as additional items. Moreover, unless limited otherwise, the terms “connected”, “linked” and variations thereof herein are used broadly and encompass direct and indirect connections and are not to be restricted to physical or mechanical connections or couplings.

In addition, it should be understood that embodiments of the present subject matter include both hardware and electronic components that, for purposes of discussion, may be illustrated as if the majority of the components were implemented solely in hardware. However, one of ordinary skill in the art, and based on a reading of this detailed description, would recognize that, in at least one embodiment, the electronic based aspects of the invention may be implemented in software. As such, it should be noted that a plurality of hardware and software-based devices, as well as a plurality of different structural components, may be utilized to implement the invention. Furthermore, and as described in subsequent paragraphs, the specific mechanical configurations illustrated in the drawings are intended to exemplify embodiments of the invention and that other alternative mechanical configurations are possible.

The present subject matter is directed to a QR code system having one or more QR codes embedded within an article of clothing, each of said one or more QR codes containing specific information or intelligence. In operation, an individual having an electronic scanning device, preferably a mobile smart phone enabled with scanning capability, can scan the QR code embedded within the article of clothing and connect that user to a particular internet address, website, online merchandise store or social media site. More preferably, a user experience is created which can lead to a direct connection to a message, website, link, action, music and/or reveal a 3D image, active or static, that emanates from the graphic on the apparel item.

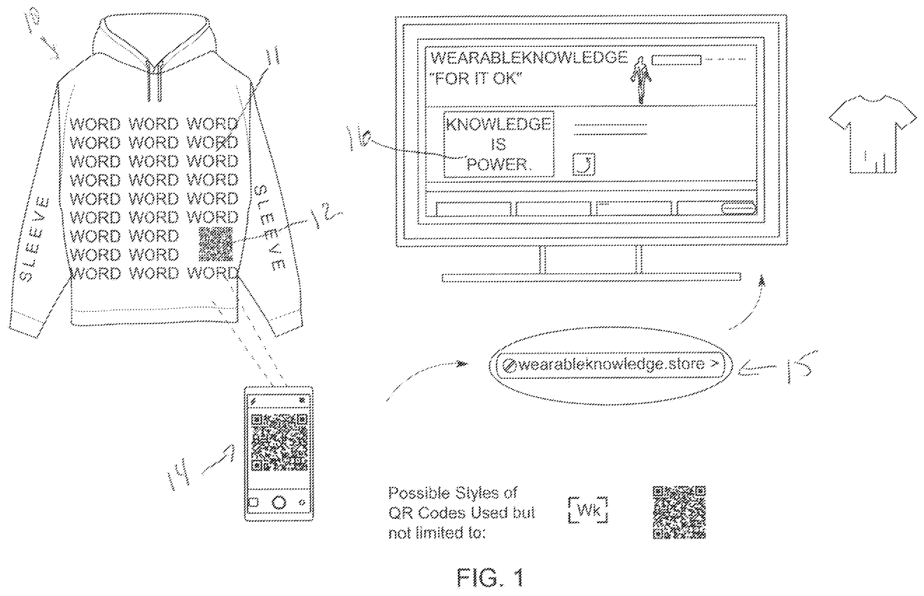

Referring to FIG. 1, a flow diagram is shown in which an article of clothing in the form of a hoodie 10 having a graphic design 11 thereupon and a QR code 12 embedded therein. A user with an electronic scanner in the form of a mobile smart phone 14, scans the QR code 12 and is connected to an internet website 15 and is presented with a greeting 16 which can be in the form of an inspiration quote (“Knowledge Is Power”), instructions to a child (“Eat Your Veggies”), a witticism or similar language including for example “Buy This Product” and linking the user to an online merchandise store. In an alternate embodiment, scanning of the QR code 12 can connect the user directly to an online merchandise store selling the article of clothing having the QR code embedded therein. The user has the option of selecting the size, color and/or features of the desired product and to purchase the product which then can be shipped to the user. The advantage of having the QR code embedded into the article of clothing is that it provides the individual scanning the QR code with a positive user experience, allowing the purchase of that particular clothing product by simply scanning the QR code and being quickly linked to the online merchandise store which is the source of the product, rather than having to take multiple steps in conducting an internet search for online merchandise stores carrying and selling the product, reviewing the results and selecting the online merchandise store which may not be the proper source of the product. And of course, the individual scanning the QR code is not required to physically visit a brick-and-mortar store and hope to find the product in the proper size and color.

For instance, an interaction between someone wearing an article of clothing having the QR code of the present subject matter embedded therein and an individual who sees the clothing product could lead to a quick conversation and sale: “Hey dude, cool graphics on that hoodie, where did you get it?” “Hey, just scan this QR code here and you can buy one”. The individual scans the code with his/her smart phone and is immediately linked to the online merchandise store which sourced the hoodie. The individual simply clicks “buy it”, checks out using a smart phone pay service and the product arrives to his/her doorstep in a matter of days. While visiting the website hosting the online merchandise store, the individual's user experience may be enhanced by providing a greeting as well as motivational quotes or graphic designs associated with that particular article of clothing. In this manner, the QR Code system of the present subject matter functions as a walking billboard for the product and provides an instant link between the product and the target audience.

In another alternate embodiment, the QR code system embedded in the article of clothing can be scanned with an electronic scanning device such as a smart phone to link an individual, particularly a younger child, to an educational website.

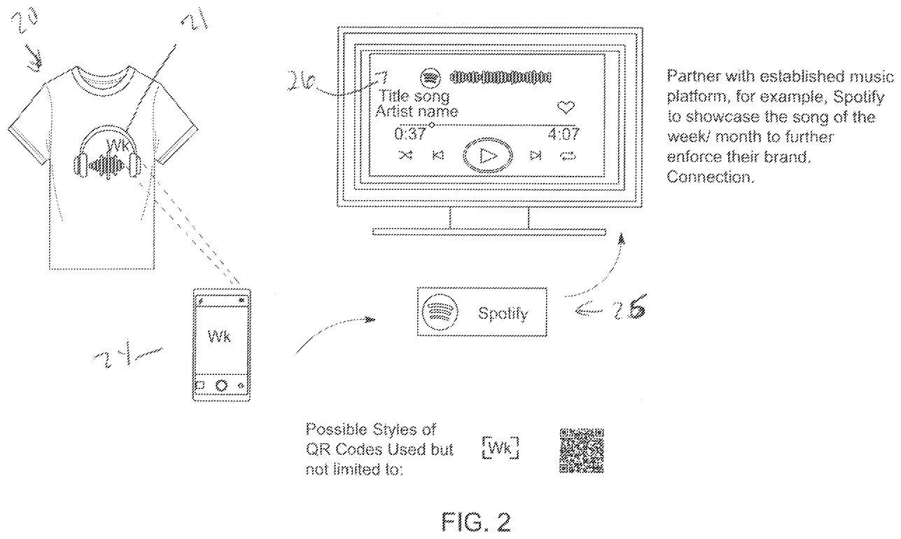

Referring now to FIG. 2, an article of clothing in the form of a tee shirt 20 is shown having a graphic design 21 thereupon and a QR code 22 embedded thereon. A user with an electronic scanner in the form of a mobile smart phone 24, scans the QR code 22 and is connected to an internet music streaming service 25 in which a particular song or artist 26 is selected. The QR code system in this embodiment simply may link the user to the music streaming service; indeed, the article of clothing may be a product provided by the music streaming service to an individual who becomes a walking billboard for the music streaming service. In another embodiment, the article of clothing may be a product provided by a recording artist or music company and the QR code may contain specific information about a particular song, album or recording artist. When the QR code is scanned, such as with a smart phone, the user is linked to that particular song, album or recording artist, either via a music streaming service or to that recording artist's website or social media page.

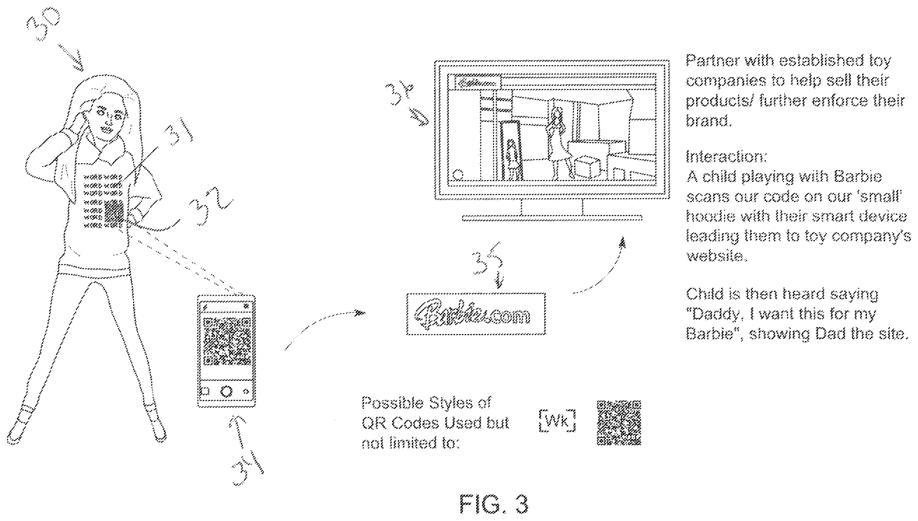

In FIG. 3, the QR code system of the present subject matter is provided on an article of clothing 30 having a graphic design 31 to be worn by a doll, such as a Barbie™ doll. The child playing with the doll can scan the QR code 32 with a smart phone and be linked to the toy manufacturer's website where the child can view other clothing articles for the doll. In this embodiment, the QR code system of the present invention can be partnered with a toy company to further promote their brands and the selling of their products.

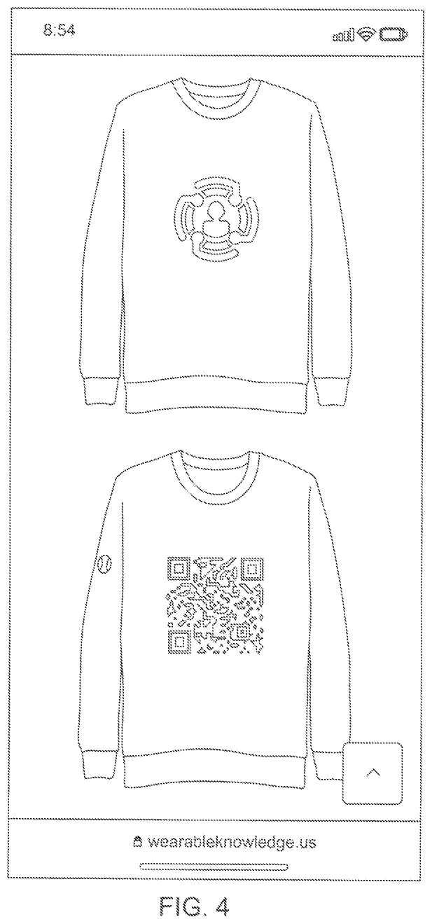

FIG. 4 illustrates the QR code system of the present subject matter wherein a QR code having specific information or intelligence is incorporated into a graphic design to be worn on an article of clothing.

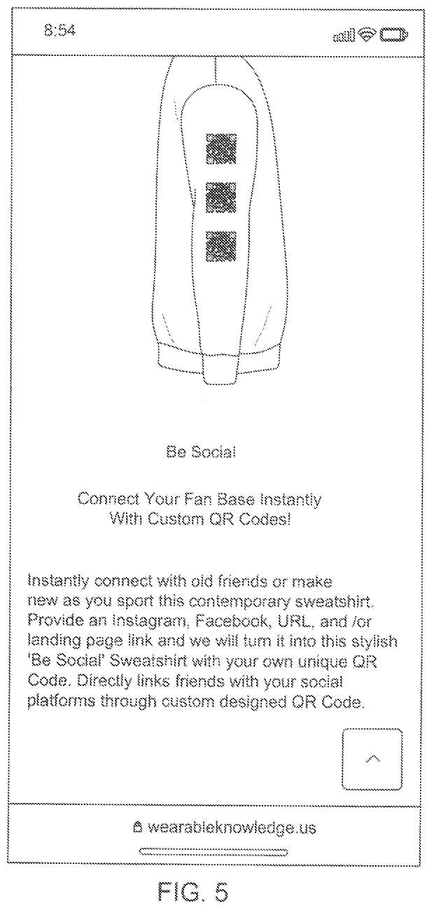

In FIG. 5, the QR code system of the present subject matter comprises a plurality of QR codes embedded on the sleeve of an article of clothing. In this embodiment, each of the plurality of QR codes contains at least a link to a particular social media platform such as Instagram, Facebook, TikTok and the like. In a preferred embodiment, each of the QR codes is custom designed for the individual wearer such that each QR code contains the necessary information to link the person scanning the QR code with a smart phone to the individual wearer's specific social media page. This embodiment of the present subject matter transforms the article of clothing into a stylish “be social” garment and directly links others to the wearer's social media pages.

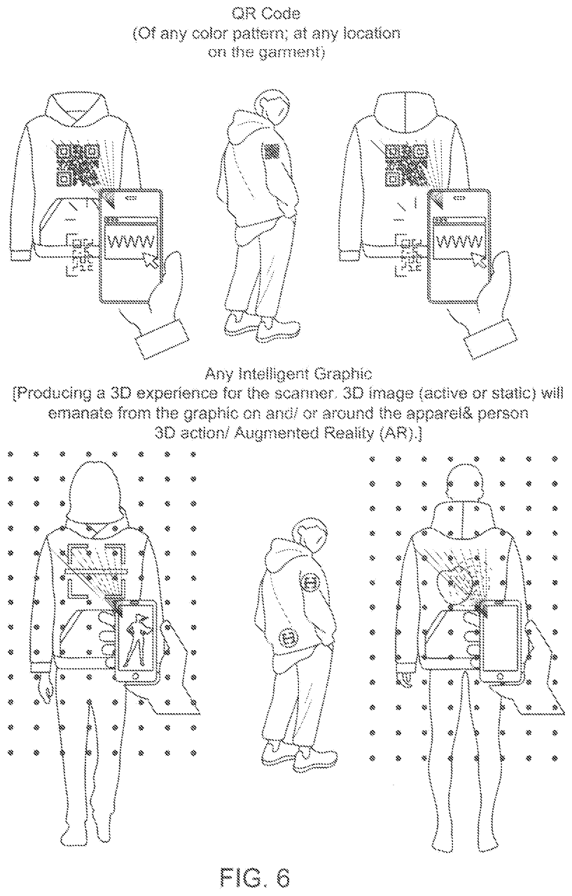

FIG. 6 illustrates another embodiment of the present subject matter wherein the QR code system of the present invention comprises a QR code embedded into an article of clothing to produce a 30 experience for the scanner. In operation, when a user scans the QR code, an active or static 30 image will emanate from the graphic on and/or around the article of clothing and the person wearing the clothing item.

In another embodiment of the present subject matter, the article of clothing is associated with wearable technology. For example, a conductive thread which has the appearance of a normal grey thread can be incorporated into a garment, the conductive thread having the ability to connect various electronic devices onto the clothing item. In this manner, rather than using normal cable charging cords to power an electronic device, the conductive thread can carry current for power and signals. While not as conductive as traces on a printed circuit board (PCB), this conductive thread makes wearing clothing possible wherein the connection is made with a stitch. Manufacturers' flexible electronic solutions are designed specifically for seamless integration into soft environments such as clothing products, upholstery, and medical textiles.

In yet another embodiment not shown, the QR code system of the present invention comprises at least one QR code embedded into an article of clothing containing specific information to activate a particular smart home device. For example, when such a QR code is scanned, the user is linked to smart home software to turn on a light, close a blind or activate a coffee pot.

As used in this specification and the appended claims, the singular forms “a,” “an,” and “the” include plural referents unless the content clearly dictates otherwise. The term “plurality” includes two or more referents unless the content clearly dictates otherwise. Unless defined otherwise, all technical and scientific terms used herein have the same meaning as commonly understood by one of ordinary skill in the art to which the disclosure pertains.

The foregoing detailed description of exemplary and preferred embodiments is presented for purposes of illustration and disclosure in accordance with the requirements of the law. It is not intended to be exhaustive nor to limit the invention to the precise form(s) described, but only to enable others skilled in the art to understand how the invention may be suited for a particular use or implementation.

The possibility of modifications and variations will be apparent to practitioners skilled in the art. No limitation is intended by the description of exemplary embodiments which may have included tolerances, feature dimensions, specific operating conditions, engineering specifications, or the like, and which may vary between implementations or with changes to the state of the art, and no limitation should be implied therefrom.

Applicant has made this disclosure with respect to the current state of the art, but also contemplates advancements and that adaptations in the future may take into consideration of those advancements, namely in accordance with the then current state of the art. It is intended that the scope of the invention be defined by the Claims as written and equivalents as applicable.

Reference to a claim element in the singular is not intended to mean “one and only one” unless explicitly so stated. Moreover, no element, component, nor method or process step in this disclosure is intended to be dedicated to the public regardless of whether the element, component, or step is explicitly recited in the claims. No claim element herein is to be construed under the provisions of 35 U.S.C. Sec. 112, sixth paragraph, unless the element is expressly recited using the phrase “means for . . . ” and no method or process step herein is to be construed under those provisions unless the step, or steps, are expressly recited using the phrase “step(s) for . . . ”

While several illustrative embodiments of the invention have been shown and described, numerous variations and alternative embodiments will occur to those skilled in the art. Such variations and alternative embodiments are contemplated and can be made without departing from the scope of the invention as defined in the appended claims.

### OTHER EMBODIMENTS

Although the present subject matter has been described with reference to teaching, examples and preferred embodiments, one skilled in the art can easily ascertain its essential characteristics, and without departing from the spirit and scope thereof can make various changes and modifications of the invention to adapt it to various usages and conditions. Those skilled in the art will recognize or be able to ascertain using no more than routine experimentation, many equivalents of the present invention described herein. Such equivalents are encompassed within the scope of the present invention.

1. A QR code system comprising at least one QR code which has been embedded within an article of clothing, said at least one QR code containing specific intelligence associated with said article of clothing, wherein an individual can access said specific information by means of an electronic QR scanner in such a manner that the individual is directly connected to an internet website which provides the individual with said specific intelligence and which facilitates the purchase of said article of clothing by said individual.

2. The QR code system in accordance with claim 1, wherein said electronic QR scanner is in the form of a mobile smart phone and wherein said internet website is an online merchandise store which is the source of said article of clothing.

3. The QR code system in accordance with claim 2, wherein said at least one QR code is incorporated within a graphic design embedded within said article of clothing.

4. The QR code system in accordance with claim 2, wherein said individual is provided with a selection of multiple motivational quotes and multiple graphic designs associated with said article of clothing thereby enabling said individual to customize said article of clothing for purchase.

5. The QR code system in accordance with claim 1, wherein upon connected to said internet website, said individual is presented with a greeting message and a purchase message.

6. The QR code system in accordance with claim 1, wherein said greeting message is an inspirational quote.

7. The QR code system in accordance with claim 1, wherein said article of clothing is designed for use with a toy, said specific intelligence being associated with said toy and wherein when said individual is connected to said internet website, said internet website is the website of the source of said article of clothing for said toy.

8. The QR code system in accordance with claim 7, wherein said toy is a doll.

9. A QR code system comprising at least one QR code which has been embedded within an article of clothing, said at least one QR code containing specific music intelligence, wherein an individual can access said specific music intelligence by means of an electronic QR scanner in such a manner that the individual is directly connected to an internet website capable of linking said individual to said specific music intelligence.

10. The QR code system in accordance with claim 9, wherein said internet website is a music streaming service.

11. The QR code system in accordance with claim 9, wherein said specific music intelligence is selected from a group consisting of a song, a music album, a recording artist, an internet website associated with said recording artist and a music streaming service.

12. The QR code system in accordance with claim 9, wherein said electronic scanner is in the form of a mobile smart phone.

13. A QR code system comprising at least one QR code which has been embedded within an article of clothing, said at least one QR code containing social media platform intelligence, wherein an individual can access said social media platform intelligence by means of an electronic scanner in such a manner that said individual is directly connected to said social media platform.

14. The QR code system in accordance with claim 13, wherein said electronic scanner is in the form of a mobile smart phone.

15. The QR code system in accordance with claim 14, wherein a wearer is dressed in said article of clothing and wherein said social media platform intelligence is customized for said wearer and identifies said wearer's personal social media page, and wherein said individual can access said wearer's personal social media page by scanning said QR code.

16. The QR code system in accordance with claim 14 comprising a plurality of QR codes, each of said plurality of QR codes containing intelligence about a distinct and unique social media platform.

17. The QR code system in accordance with claim 15, comprising a plurality of QR codes, each of said plurality of QR codes containing intelligence about a distinct and unique social media platform.

18. A QR code system comprising at least one QR code which has been embedded within an article of clothing being worn by a user, said at least one QR code containing intelligence to produce a 3D experience, wherein an individual can access said 3D experience by means of an electronic QR scanner in such a manner that an active or static 3D image will emanate from said graphic on or around said article of clothing and the user wearing said article of clothing.

19. The QR code system in accordance with claim 18, wherein said electronic scanner is in the form of a mobile smart phone.

20. A QR code system comprising at least one QR code which has been embedded within an article of clothing, said at least one QR code containing specific intelligence to activate a smart home device, wherein an individual can access said specific information by means of an electronic QR scanner in such a manner that said individual is connected to a smart home software application for activating a smart home device.

21. A QR code system in accordance with claim 20, wherein said electronic QR scanner is a mobile smart phone.

22. A QR code system comprising at least one QR code which has been embedded within an article of clothing, said at least one QR code containing specific intelligence associated with learning website, wherein an individual can access said specific information by means of an electronic QR scanner in such a manner that the individual is directly connected to said learning website.
